(19) United States
(12) Patent Application Publication
(10) Pub. No.: US 2006/0142948 A1
(43) Pub. Date: Jun. 29, 2006

(54) Multiple-channel bias removal methods with little dependence on population size

(76) Inventor: James M. Minor, Los Altos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/021,948

(22) Filed: Dec. 23, 2004

(51) Int. Cl. G06F 19/00

(52) U.S. Cl. 702/19

(57) ABSTRACT

Methods, systems and computer readable media for removing labeling-bias factors affecting data from two or more data sources after single source biasing factors have been removed to the extent possible. Respective data points from the data sources are considered in combination to generate a population of data points. The population of data points is subdivided into portions of the overall population and, for each portion, the data points are sorted within that portion, relative to values of all other data values in that portion. A function is then generated for each portion from the sorted data points for that portion. For each portion, a value representative of highest population density of data points within that portion is identified. The identified values are fitted to a predetermined curve, and values of all data points are adjusted relative to the fitted values.

### BACKGROUND OF THE INVENTION

Researchers use experimental data obtained from arrays and other similar research test equipment to cure diseases, develop medical treatments, understand biological phenomena, and perform other tasks relating to the analysis of such data. However, the conversion of useful results from this raw data is restricted by physical limitations of, e.g., the nature of the tests and the testing equipment. All biological measurement systems leave their fingerprint on the data they measure, distorting the content of the data, and thereby influencing the results of the desired analysis. For example, systematic biases can distort array analysis results and thus conceal important biological effects sought by the researchers. Biased data can cause a variety of analysis problems, including signal compression, aberrant graphs, and significant distortions in estimates of differential expression. Types of systematic biases include gradient effects, differences in signal response between channels (e.g., for a two channel system), variations in hybridization or sample preparation, pen shifts and subarray variation, and differences in target inputs (e.g., nucleic acid inputs such as RNA, cDNA or genomic DNA).

Gradient effects are those in which there is a pattern of expression signal intensity which corresponds with specific physical locations within a chemical array and which are characterized by a smooth change in the expression values from one end of the array to another. This can be caused by variations in array design, manufacturing, and/or hybridization procedures.

In dual-channel systems, it is well known that the two dyes used to evaluate the binding of target molecules to probes on an array do not always perform equally efficiently, for equivalent target concentrations, uniformly across the whole array. In particular, the red channel often demonstrates higher signal intensity than the green channel at higher target abundances. Even when comparing results from two single-channel experiments, there may be differences in dye performances, even when the same dye is used, such as when different experimental conditions, either intended or unintended, occur when running each of the experiments. Also, for label intensity may not follow an ideal performance curve over the range of analyte concentration. For example, for drug discovery experiments, label intensity may not follow the ideal does-response curve over the range of the analyte (e.g., mRNA) concentration. For example, red dye tends to accelerate brightness at high concentrations beyond the typical sigmoidal profile.

Variations in hybridization and sample preparations can cause warpage to occur in the expression values in arrays. This can prevent comparative analysis across batches of arrays and further distort analysis results. “Warpage” or “warping” refers to a result where, when comparing results from two or more channels, a user sees patterns produced by the ubiquitous population of “constant” (“inert”) genes that are non-ideal in shape and form. The pattern deviates from the symmetric, ellipsoidal pattern that is expected when signals representing inert genes are accurately represented.

Subarray variations are forms of systematic biases in which different probe subsets within the array demonstrate significantly different performance characteristics. In particular, there may be multiple subsets that have different average signal intensities. This is sometimes referred to as “blocking” within the resultant array pattern, due to the visual, block-like appearance resultant from the probe subsets. These subarray variations may be related to variations in a manufacturing process, e.g., such as failures or inconsistencies in individual pens/nozzles in an ink jet deposition process or other manufacturing discreteness or boundaries within the array that would tend to “block” or subdivide the array into portions along such boundaries or discrete effects, as well as other process details.

After removing single channel systematic biases, there still may remain biases that occur in comparing one channel with another, as noted. Dye bias is one of the more prominent of this type of bias. Many current dye normalization techniques estimate the highest signal density of inert genes as a function of abundance. One such approach, sometimes referred to as rank normalization, compares the ranks (based on abundance) of genes across experiments and identifies those genes that change rank values the least across the set of experiments being considered. This technique requires the consideration of multiple arrays to determine rank consistency of each gene represented. These genes are then considered to be the inert genes used for reference for normalization of the intensity values of all the genes in the experiments. However, a problem with this approach, is that even if small amounts of random error are existent in one experiment versus another, this can cause the ranks of some genes which would otherwise be considered to be inert genes, to change significantly, and thus be erroneously ruled out from being considered inert genes. The rank normalization also is less effective at the end regions of the intensity signal range (i.e., those regions identifying very low abundance and very high abundance) since the data points are more sparse there and may not be enough to validate this technique.

Thus there remains a need for improved systems and methods for normalizing biological data such as data read from arrays. Particularly, more versatile methods and systems for dye normalization of biological data are needed.

### SUMMARY OF THE INVENTION

Methods, systems and computer readable media for removing labeling-bias factors affecting data from two or more data sources after single source biasing factors have been removed to the extent possible are provided to accomplish consideration of respective data points from the sources in combination; subdividing the combined respective data points into portions of the overall population of combined data points; for each portion, sorting the data points that are members of that portion according to relative values of the data points that are members; for each portion, generating a function from the sorted data points belonging to that portion; for each function, identifying a value representative of highest population density of data points within the respective portion; fitting the values representative of highest population densities within the portions, respectively to a predetermined curve; and adjusting values of all data points relative to the fitted values.

Methods, systems and computer readable media for dye-normalizing array data obtained from two or more channels is provided, including considering respective signal values from at least two channels, in combination; subdividing the combined population of respective signal values into portions of the overall combined population of signal values; for each portion, sorting the signal values that are members of that portion according to relative values of the signal values that are members; for each portion, generating a function from the sorted signal values belonging to that portion; for each function, identifying a value representative of highest population density of signal values within the respective portion; fitting the values representative of highest population densities within the portions, respectively to a predetermined curve; and adjusting values of all signal values relative to the fitted values based upon the adjustments made to fit the fitted values.

The present systems may include features for performing methods according to the invention, which features may be embodied within hardware, software, firmware, or combinations thereof.

Forwarding, transmitting and/or receiving a result obtained from any of the methods described herein are also encompassed within the scope of the invention.

These and other advantages and features of the invention will become apparent to those persons skilled in the art upon reading the details of the methods, systems and computer readable media as more fully described below.

### BRIEF DESCRIPTION OF THE DRAWINGS

FIG. 1 is a graph showing an expected ellipsoidal pattern of signal data values when such signal values are plotted against one another from two channels of an array, for example.

FIG. 2 shows a graph of data values wherein the expected ellipsoid is “warped” or curved, due to inter-channel/labeling-biasing effects.

FIG. 3 shows a histogram generated from data such as data shown in FIG. 2, for example, to identify a ridge of greatest density values.

FIGS. 4A, 4B and 4C illustrate distortions of the inert data points from ideal values, and directional errors that may occur.

FIG. 5 is a flow char containing events that may be carried out according to an embodiment of the present invention.

FIGS. 6A and 6B illustrate two techniques for repositioning populations of data.

FIG. 7 shows a population of data points having been repositioned substantially along the X or abundance axis.

FIG. 8 illustrates a plot of a cumulative distribution function for identifying a mode of one of the portions or bins of data being processed.

FIG. 9A shows adjustment of the data values representing the highest density values identified in the portions or bins, and corresponding adjustment of all other data values.

FIG. 9B illustrates repositioning the adjusted values in the population, by inverse projection or reverse rotation, for example.

FIG. 10 illustrates a typical computer system in accordance with an embodiment of the present invention.

### DETAILED DESCRIPTION OF THE INVENTION

Before the present systems methods and computer readable media are described, it is to be understood that this invention is not limited to particular data or algorithms described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a channel” includes a plurality of such channels and reference to “the probe” includes reference to one or more probes and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

A “microarray”, “bioarray” or “array”, unless a contrary intention appears, includes any one-, two- or three-dimensional arrangement of addressable regions bearing a particular chemical moiety or moieties associated with that region. An array is “addressable” in that it has multiple regions of moieties such that a region at a particular predetermined location on the array will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. No. 6,242,266; 6,232,072; 6,180,351; 6,171,797 and 6,323,043. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. However, arrays may be read by any other methods or apparatus than the foregoing, other reading methods including other optical techniques or electrical techniques (where each feature is provided with an electrode to detect bonding at that feature in a manner disclosed in U.S. Pat. Nos. 6,251,685, 6,221,583 and elsewhere).

The term “abundance” refers to a valuation of gene expression. For example abundance can be measured by signal intensity read by scanning an array with a scanner. Abundance is indicative of MRNA concentration as produced from activity of the gene being considered.

“Housekeeping genes” refer to a set or list of genes that are detected by analyzing prior existing data, wherein the data indicates that such genes identified as housekeeping genes remain substantially neutral over all of the data considered. Such housekeeping genes are then applied prospectively in new experiments, as they are also expected to remains substantially neutral in the new experiments and can thus be used as reference values.

“Inert genes” are genes that are used as references, as they are considered to remain substantially neutral for data being considered. Thus, inert genes may refer to genes that are detected as being consistently neutral (i.e., not significantly expressed or inhibited) based upon analysis of the expression data at hand (e.g., across a set of experiments currently being analyzed). “Inert genes” (sometimes also referred to as “constant genes”) may refer to genes which are substantially inert for a specific study. Hence, these genes tend to have “constant” expression levels in the study. The population properties of such genes are constant for all experiments in the study and are therefore useful for normalization purposes. Additionally or alternatively, housekeeping genes may be assumed to be inert genes.

When one item is indicated as being “remote” from another, this is referenced that the two items are at least in different buildings, and may be at least one mile, ten miles, or at least one hundred miles apart.

“Communicating” information references transmitting the data representing that information as signals (e.g., electrical, optical radio or other signals) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

All patents and other references cited in this application, are incorporated into this application by reference except insofar as they may conflict with those of the present application (in which case the present application prevails).

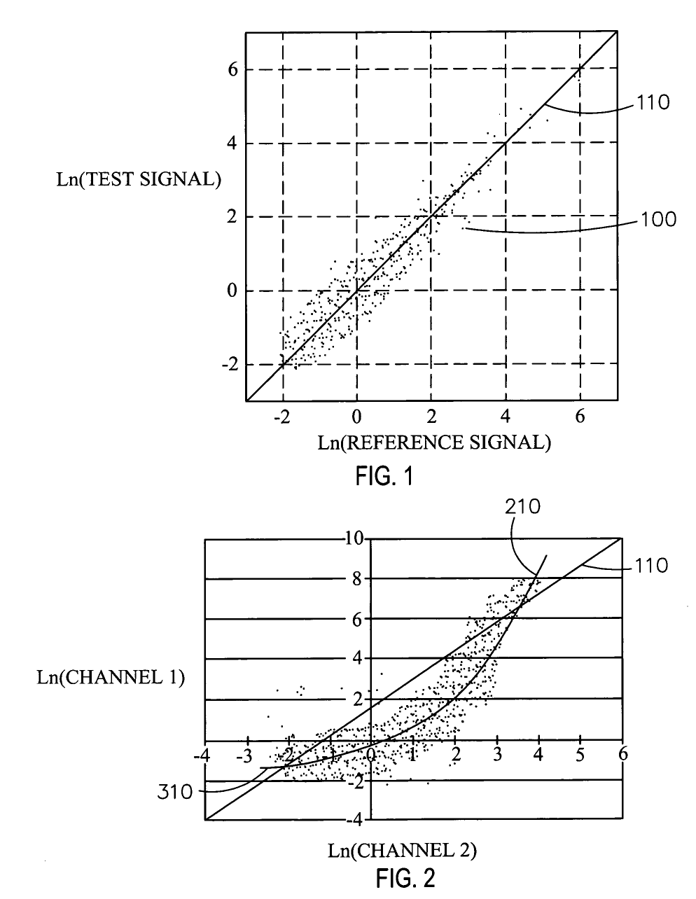

In order to provide useful results from experimental data obtained from chemical arrays, for example microarrays, or other similar research/test equipment the raw data provided from such equipment must be processed to remove biases that may exist in the raw data that would otherwise lead to inaccurate readings, results and/or conclusions. For example, in consideration of two channels of data, such as two channels from a dual-channel array, or two single channel arrays, or the like, after removing single channel biases, the data from each channel may be plotted on a log-log (e.g., ln-ln) basis, such as demonstrated in FIG. 1. Single channel effects or biases may include gradients, dye inconsistency, writer patterns, nozzle noise, substrate patterns, glass energy patterns, hybridization effects, washing effects, auto fluorescence effects, scratches, blots, and/or the like, etc. Processing to remove for such single channel biases is discussed in co-pending, commonly assigned application Ser. No. 10/422,570. filed Apr. 23, 2003 and titled “Microarray Performance Management System”, which is hereby incorporated herein, in its entirety, by reference thereto.

The signal for each corresponding probe of each channel is plotted in FIG. 1, resulting in the generally ellipsoidal grouping 100 of plotted data points as shown. In the example shown in FIG. 1, a test signal (such as experimental data, for example) is plotted against a reference signal (which may be an average of a group of arrays that may be determined to establish reference values, for example), so that errors in the plots, in this example, are, by definition in the direction of the test signal plots. In other instances, both channels plotted against one another may be experimental or test signals from experimental data, so that either or both channels may contain error for any particular plotted points for a probe. Examples of sources for the signals that may be plotted against one another include two color channels from a two-channel array, single channels from each of two different arrays, wherein the channels may include the same or different colors; two channels from an array that includes more than two channels, etc. A common example is where data points (signals) from corresponding probes for genes on two array channels are plotted against one another. In these instances, it is not unusual to have about 20,000 to about 40,000 probes to plot. For example, for drug discovery experimentation, the generally ellipsoidal grouping of plotted data signal points 300 should be proximal to a line passing through the origin of the plot at a forty-five degree angle to the vertical and horizontal axes. Points that fall on the diagonal line 110 (or an insignificant distance therefrom) are representative of inert genes or housekeeping genes for analysis of probes coding for genes being experimented upon.

The further the points are from the forty-five degree line 110, the more it indicates that that particular gene, or entity being described by the signals is doing something different in one channel than it is doing in the other. For example, if one channel is data with regard to a reference or control sample, and the other channel is data from a diseased tissue sample, then a data point which is far from the forty-five degree diagonal line may represent a gene that is being significantly expressed (or suppressed) relative to its activity in the control sample.

After each channel has been processed to remove non-biological bias factors to the extent possible, and a plot such as described with regard to FIG. 1 is made, the inert signals (e.g., signals taken from the probes representing the inert genes) may not be on the forty-five degree line 110 passing through the origin and also may not be aligned along a straight line at all. FIG. 2 shows such an example, where the highest density of plotted points extends along the curve 210. The highest density of inert genes occurs along the line indicating the highest density of points. For experiments such as drug discovery experiments, the highest density of inert genes should be represented along a line or ridge of highest density of the plotted points, and this line should substantially coincide with the diagonal line 110. A line that is off the diagonal 110 and/or is curvilinear (which may or may not intersect the diagonal line 110) such as curve 210 shown in FIG. 2 is not uncommon, due to inter-channel biasing effects, such as dye bias, for example. Examples of such lines include signals that are equally represented in both channels, resulting in an ellipsoid pattern of plotted points having a major axis parallel to the diagonal line 110, or angled to and intersecting line 110, or curvilinear, as already described, an example of which is shown in FIG. 2. For a single label (e.g., single dye) system, a reference channel is used to create the plot of the diagonal pattern. The reference channel is assumed to have much less error associated with its intensity values of inert probes, as compared to the other channel against which it is referenced. Hence, inert probes are much better defined for the reference channel. Therefore the fuzziness and any distortion (e.g., warping) of the diagonal pattern of inert probes is primarily assigned to the direction of the non-reference label or dye channel.

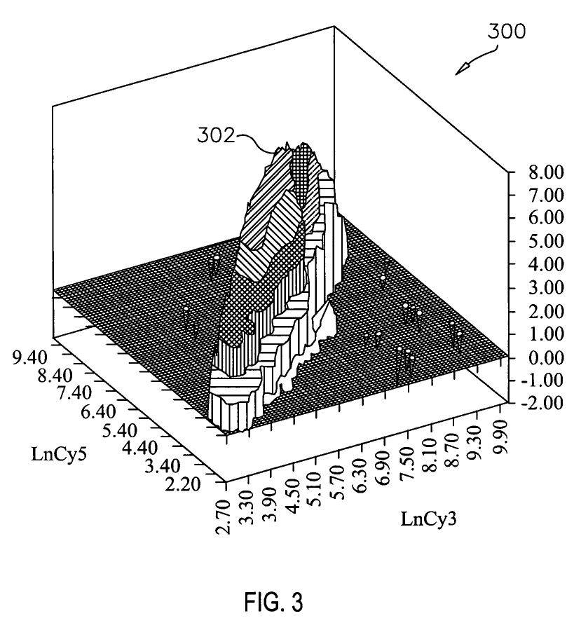

In order to correct for such biasing effects, an approach taken in application Ser. No. 10/422,570 is called “de-warping”, which may be applied to both channels of a two-channel system, or may also be applied to more than two channels simultaneously. In essence de-warping corrects the pattern created by inert genes in the plot of the two or more channels of log signal (In signal of scanner RLU signals) on a two-sample (or more than two sample) plot, such as the curve 210 shown in FIG. 2, and aligns the points along curve 210 with the diagonal 110, while adjusting all other data points correspondingly thereto. Initially a two-dimensional histogram (or multidimensional histogram, i.e., greater than two-dimensional) is formed by binning (i.e., data partitioning to form frequency (count) plots, i.e., histograms) both axes to form grid squares and plotting frequency-of-occurrence within these squares on a third axis (or additional axis). The resulting histogram 300 represents the density of points in the two-sample plot (in the example shown), and the frequency density resembles a mountain range, see FIG. 3. The major mode of this histogram is an elongated ridge 302 formed by the population of inert genes ranging over their typical variations in abundance. This ridge 302 provides a useful definition of an expression baseline, since such inert genes are neutral, or inert, to the biological perturbations of the study experiments. The ridge is then mathematically transformed into a linear straight line according to the relative error properties of the signal channels. If the channels all have similar sized errors, then the orthogonal deviation from this ridge locus to the diagonal is subtracted for each probe, so that the ridge locus is effectively corrected to the nearest point on the diagonal for each probe, and hence, rotated to the desired forty-five degree diagonal position. If select channels are designated as essentially error-free, i.e., reference channels, then the deviation from this ridge locus to the diagonal but orthogonal to such reference channels is subtracted for each probe, so that the ridge locus is effectively corrected to the diagonal for each probe leaving reference values unchanged, and hence projected to the desired forty-five degree diagonal position. In summary the de-warp correction is only in the direction of significant error. “Noisy” channels (i.e., non-reference channels) are rotated to the desired forty-five degree diagonal line by rotating each axis along which each noisy channel is plotted to coincide with the forty-five degree axis, and non-noisy channels (such as reference channels, for example) are orthogonally projected to the desired forty-five degree diagonal line. Subsequent dewarping on the rotated noisy axis/axes creates consistency among all noisy channels. Dewarping on a reference axis creates consistency to the reference channel. For example, a reference channel may be used to enforce an ideal dose-response (e.g., concentration—label) association. The final corrected (“de-warped”) two-sample plot has the expected pattern for the population of “inert” genes from two ideally equivalent channels. Thus de-warping affects dye-normalization among the channels being plotted, and may correct for other inter-channel biasing effects, but the main inter-channel biasing factor is generally agreed to be dye bias. This technique is sometimes also referred to as modal dye-normalization, since the mode of each two-dimensional histogram is found at the maximum peak and the peaks of the two-dimensional histograms weave along the ridge 302 of the three dimensional histogram 300. The ridge defines the maximum probability of simultaneous intensity levels of all channels at each abundance level on the diagonal.

One advantage of the present techniques described herein, is that they are effective for signal populations much less than 200, having been proven effective for signal populations of around 150 at any abundance levels. The present approach may provide reliable results using even smaller populations than around 150 if the population is mainly random with some reliable inert members. Further, at the extremes of the data (i.e., near the ends of the major axis running through the ellipsoid of plotted points), the data becomes sparse and it becomes more difficult to reliably identify the inert genes in those locations, even when there is a substantial population of signals. Still, further, for large populations of signals, the approach of application Ser. No. 10/422,570, while very effective in this situation, becomes computationally intensive. For example, an array analysis may include twenty probe pairs (40 probes) for each gene that is analyzed, and the total number of genes being analyzed in the experiment may be on the order of twenty thousand. Processing according the approach described in application Ser. No. 10/422,570 becomes computationally intensive for this large number of data points, since the calculation of density is an n² process, where n is very large in this instance (i.e., on the order of 800,000). Therefore the present approach may be preferred even when the number of signals are sufficient to use an approach as described in application Ser. No. 10/422,570, since the present approach does not require density calculations to be performed.

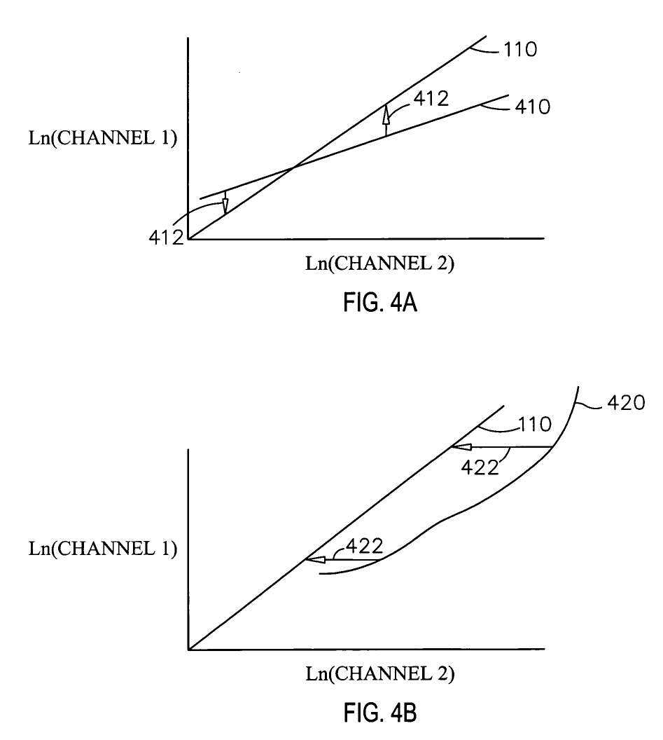

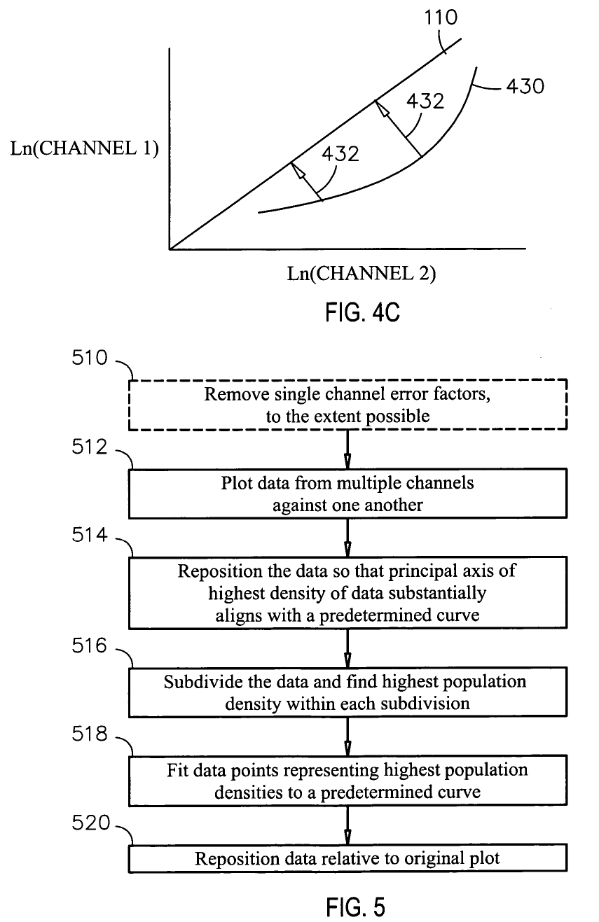

The present approach is less computationally intensive as it is based on sorting, which computations are base on nln(n). Similarly, the present approach mathematically transforms an identified ridge into a linear straight line according to the relative error properties of the signal channels, although by techniques which are less demanding regarding requirements for a sufficient signal population, and which are less computationally intensive, as already noted. Reference is now made to the schematic representations of FIGS. 4A-4C, where the signal point plots have been left out for simplicity, and only the ridge curve identifying the densest locations in the plot are shown relative to the diagonal line 110. Further, these examples are with regard to two channel analysis, also the same principles apply to multiple channel analysis where more than two channels are considered.

Referring to FIG. 4A, assuming Channel 2 is a reference channel, then the signals from Channel 2, by definition, are considered to be error-free. Accordingly, the error in line 410, and all other data points in the ellipsoid (not shown) from which line 410 is generated is considered to be in the direction of Channel 1 only, since Channel 2, by definition, does not contribute any error (after all single channel factors have been eliminated to the extent possible, of course). Therefore correction for error in the example of FIG. 4A is in the vertical direction only, see the exemplary directional arrows 412, along which the data points are corrected to conform line 410 with line 110. Similarly, if Channel 1 is a reference channel, as illustrated in the example of FIG. 4, then correction for error will be made only in the direction of Channel 2, i.e., horizontally, as indicated by arrows 422 to conform curve 420 with line 110.

Referring now to FIG. 4C, if both Channels 1 and 2 are considered to contribute equally to error, then correction of curve 430 will be made equally in both horizontal and vertical directions, i.e., in directions 432 perpendicular or normal to and toward diagonal 110. Further, if it is possible to measure or otherwise estimate the relative contribution to error between the channels, then the directionality of error correction can be rotated accordingly (as would be readily apparent to one of ordinary skill in trigonometry) so that the directionality of the error minimization procedure is proportional to the relative effects on error of the channels being considered.

Thus, using the current approach, once the single channel errors have been removed to the extent possible at event 510 and the signals from multiple channels have been plotted against one another at event 520, such as by a log-lo plot in the manner described above, for example, the resultant data points in the plot are processed to align the ridge of greatest density along the forty-five degree diagonal line, which was the same goal as in the previous approach discussed above, albeit by different processing techniques are described hereafter.

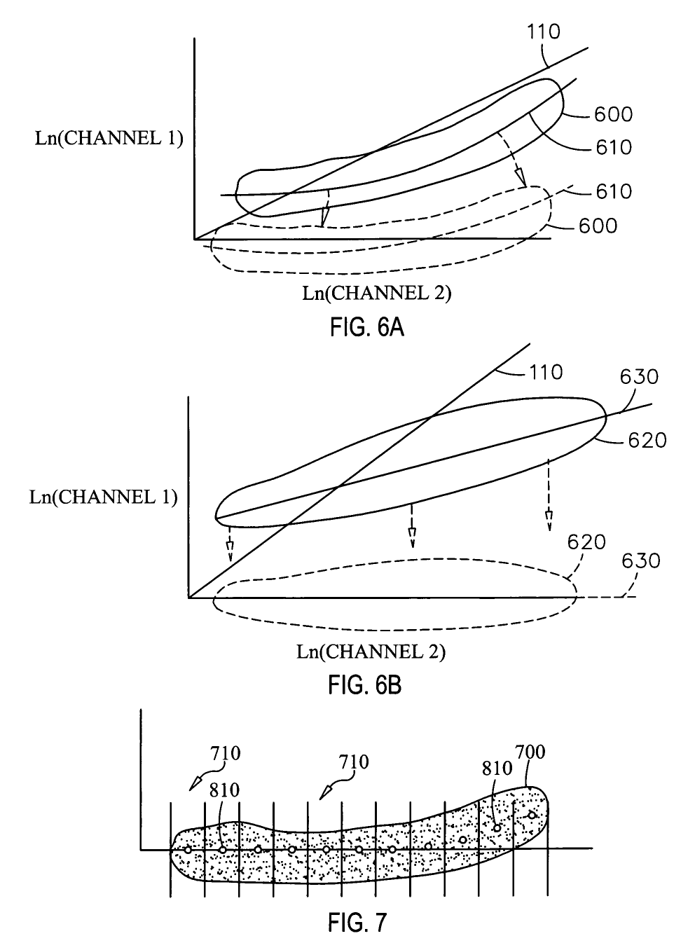

The entire plot may be re-positioned so that the ridge lies on, or approximates as near as practically possible, one of the axes of the graph on which the plot is made (event 514). The techniques for doing this may vary depending upon the characteristics of the channels from which the signals for the plot were taken. For example, referring to FIG. 6A, an example is shown where both Channel 1 and Channel 2 are considered to be equally likely to contribute equal amounts of error. In such a case, the diagonal 110 needs to be rotated down to the X-axis to correctly account for error in both directions, and similarly the plot 600 and ride 610 needs to be rotated to the X-axis, after which further processing can be performed to minimized the error in the vertical direction, which is effectively the same as minimize the error in a direction perpendicular to the diagonal 110 when it is positioned at a forty-five degree angle to the X-axis. Note that the data points are not shown in FIGS. 6A-6B for simplicity of illustration and explanation, but rather, an imaginary outline 600, 620 of the ellipsoid that the data points form in each plot is shown, along with the respective ridges 610, 630.

One way of rotating the plot 600 (and correspondingly, the dense ridge 610) is by principal component analysis (PCA) a known statistical technique (e.g., see “A tutorial on Principal Components Analysis”, http://www.cs.otago.ac.nz/cosc453/student_tutorials/principal_components.pdf, which is hereby incorporated herein, in its entirety by reference thereto, and a copy of which was downloaded on Dec. 10, 2004 and is being submitted as a disclosure document with regard to the present disclosure). Application of PCA captures the Log intensity pattern as a hyper-ellipse. Using PCA, the long axis of the plot 600 is rotated down to substantially coincide with the horizontal axis of the graph as shown in FIG. 6A. Generally, the long ellipse axis of the noise cloud plotted from any number of noisy channels can be orthogonally transformed (e.g., including rotations, inflections, inversion, etc.), using PCA, to a coordinate axis. By using principal component analysis, the correct amount of rotation of the plot needed to accurately position it over an axis is achieved even when the rotation needed is less than or greater than forty-five degrees. As noted above, this procedure can also be performed in high dimensional space, for example, where three or more channels are considered at the same time.

Another approach may be taken when one of the signals is a reference channel or otherwise considered to be error free. Referring to FIG. 6B, Channel 2 in this example is a reference channel and therefore, by definition, does not contribute error. In this case, the data points in plot 620 can be projected to the horizontal or X-axis, so that ridge 630 substantially overlies the X-axis, as the direction of error is all vertical in this example. Such projection can be carried out by regression analysis, since this example meets a requirement for proper use of regression analysis, that requirement being that the error associate with one variable the values of which are regressed against another variable is much greater than the error associated with the other variable. By performing a regression analysis and taking the residuals from the analysis, this effectively rotates the plot down to the X-axis (in this example) with the residuals characterizing the errors in vertical directions from the X-axis. Note that this technique can also be used for higher dimensional analysis and processing, such as when more than two channels are being considered and at least one channel is a reference channel.

Once that the data has been repositioned as described above, then the data may be subdivided at event 516 and further processed to determine a data point representative of a modal value in each subdivision. Subdivision may be accomplished in various ways. One technique, as shown in FIG. 7 is to simply grid the entire plot 700 (e.g., along the abundance axis) with subdivisions 710. Note that the distance between the vertical lines forming the subdivisions 710 may vary from subdivision to subdivision. That is, the widths of each subdivision do not have to all be created equal, but may be set to correspond to relative data point densities along the length of the plot. This can be particularly useful toward the ends of the plots where data points tend to become more sparse. Hence, subdivisions at the ends of the plot 700 may be made larger so as to capture sufficient data points for processing. Additionally, or alternatively, a smooth fit can be produced by inertia to extend the ridge into the sparse zones. The freedom to define subdivisions to correspond to relative data point densities provides an advantage over the rank normalization approaches, and even the approach in application Ser. No. 10/422,570, wherein scarcity of data toward the ends of a plot can make it difficult to obtain reliable results in those locations using the prior methods. Subdivision size can be altered anywhere along the population, e.g. any portion of the population where there is concern over the number of data points, e.g., a subdivision can be narrowed in a very high density area of the plot to reduce the number of data points to be considered and/or a subdivisions may be widened anywhere there is a scarcity of data points, to increase the number for consideration.

Another technique for subdividing is to employ a moving window. In this approach, the moving window may be of fixed width or adaptive to assure adequate membership of data points within each window considered, and may also be applied to define the subdivisions in different ways. For example, a moving window may be placed so that the windows identified are adjacent one another, so that, when finished, the windows/subdivisions would appear similar to that shown in FIG. 7. Alternatively, a window of fixed width may be incrementally moved by a fraction of the width of the window with each increment, so that the defined subdivisions overlap one another, or an adaptive width window may be incrementally moved by a fraction of the width of the preceding window size with each increment to provide overlapping subdivisions. The redundancy of the points considered provides a greater number of identified modal points that are closer together, but with the compromise that these modal points are noise correlated. Overlapping creates correlation in error which induces bias in true signal patterns while reducing random error. This compromise from overlapping varies and is application dependent. Further alternatively, the window may be moved by an amount that is adjustable, so that some increments are moved greater distances than others, resulting in unequal size subdivisions. Thus for example, closer increments may be used where the ridge is changing more rapidly, so that the faster sampling rate provided by the closer increments can better define the increase rate of change. Such unequal sized subdivisions may be identified for the same reasons provided above. Note that, although a visualization of a window may be provided to pass over plotted data points to establish bins in any of the manners discussed above, that, alternatively, a window need not be visually established or displayed, nor do the data points necessarily have to be visually displayed or plotted. The same mathematical results may be obtained by defining a “window” as a mathematical range and then sampling the population of data points which have been ordered in the same manner that they would appear if plotted as described above, while incrementing the window according to any of the techniques already described.

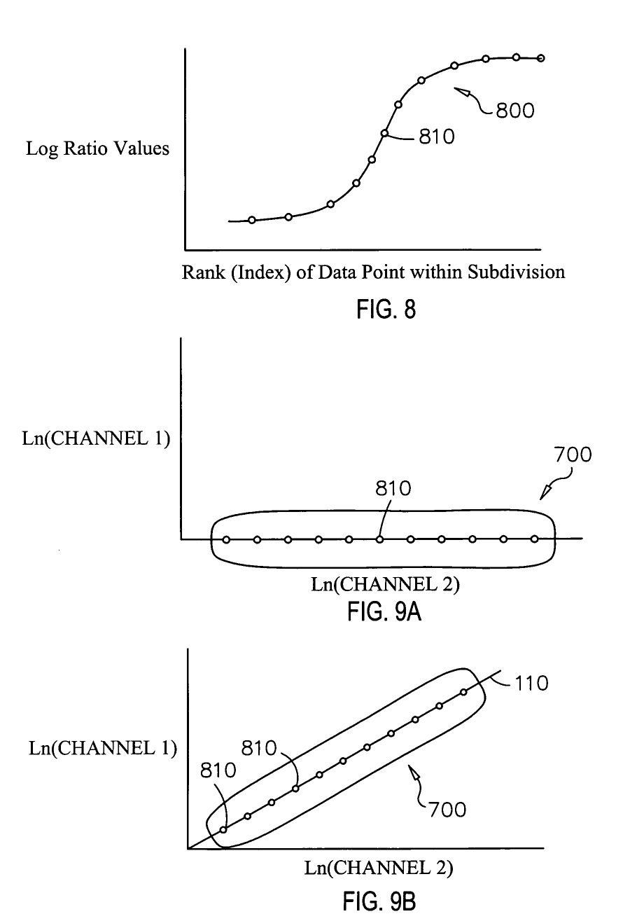

For each subdivision 710, rather than calculating the densities as in the previous approach, the current approach sorts the data points based upon the log ratio values of the data points (log of the differences of the values between the channels being compared, e.g., sort according to the values on the vertical axis). By sorting within each subdivision 710 of probe abundance based on log ratio, a characteristic cumulative distribution function (CDF) profile may be plotted as a function of abundance. An example of such as plot is shown in FIG. 8, wherein the log ratio values of the data points within a subdivision 710 are plotted against their rank as determined by the sorting process. Such a plot 800 is typically characterized by an “S curve”. The inflection point 810 of each profile 800 marks the log ratio value for highest population density of inert genes for the subdivision that it characterizes, or mode of the function. The mode corresponds to the highest point of the function, thereby representing the highest density population for the subdivision. Other techniques that use, for example, rank normalization, or calculate median values to attempt to identify the highest population density values, are approximations to finding the modal values of the function, and can vary quite significantly for populations that are asymmetric, for example. The inflection point 810 may be estimated by calculus, regression, or density calculations. Inflection point 810 may be identified using a convolution filter (Fast-Fourier Transform (FFT)).

After identifying the inflection point of each subdivision 710, a smooth function may be generated from the inflection points 810 to track the ridge continuously, and the smooth function is further statistically processed for fit to a predetermined curve (event 518) e.g., a straight line that coincides with the X-axis in this example, thereby accomplishing de-warping, including dye normalization. Generally speaking, the predetermined curve will be one that defines the characteristics of the locations expected for data points to be used as standards, have values form which the remainder of data points may be compared. Filtering, such as with a low pass filter, or other filter, for example may be applied to smooth jitter between adjacent estimates of inflection points. All other data points in the population are adjusted proportionally relative to the adjustments made to the smooth function to achieve dye normalization via a smooth, jitter-free ridge, as may be observed by viewing FIG. 7 and FIG. 9A. After modifying the values of each data point accordingly as described above, and represented in FIG. 9A, the entire population may then be reverse-rotated, or inverse projected at event 520 (depending upon the operation that was carried out to move the population down to the X-axis initially), back so that the straightened function including the inflection point values 810 coincides with the diagonal or concordance line 110. The population of data points 700 are now de-warped (e.g., dye-normalized) and provide usable data values from which inter-channel biasing effects have been removed to the extent possible, making all channels dye-identical or dye-normalized and ideal.

The use of cumulative distribution functions is advantageous as not as many data points are required to enable the determination of reliable results as this technique does not rely as heavily on density determinations, relative to methods that calculate ridge density. Because fewer data points are necessary, the present techniques are ideal for relatively small arrays and subarrays, although the present techniques are also applicable to relatively larger arrays and large populations of data points. The sorting is a function of nln(n) which is less computationally intensive, and therefore faster and less expensive than the calculations of densities, which are functions of n². Further, the present techniques are not geometrically based and do not require the identification of a center of a feature or highest density region of a feature or most consistent probe representation on a feature, but finds the best signals from a feature regardless of any of the geometric factors characterizing the feature.

Further, the present method is more robust near the end points of the population, since bin/subdivision sizes can be varied to account for the sparsity of data points near the end points, thereby providing more reliable results than previous approaches, including rank normalization techniques as well as ridge density techniques. Further, it is relatively fast and computationally easy to determine the inflection pints of the cumulative distribution functions and apply these to characterize a ridge of highest population density throughout the population.

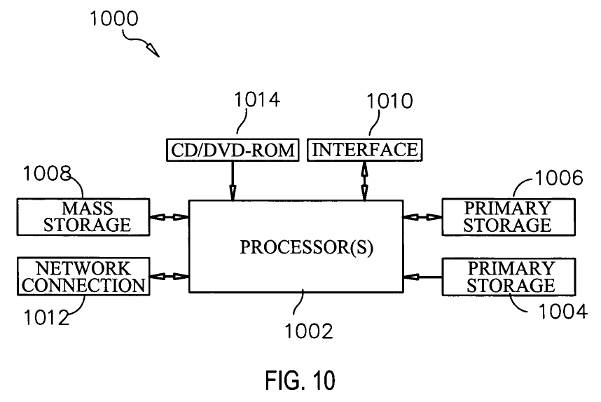

FIG. 10 illustrates a typical computer system in accordance with an embodiment of the present invention. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). As is well known in the art, primary storage 1004 acts to transfer data and instructions uni-directionally to the CPU and primary storage 1006 is used typically to transfer data and instructions in a bi-directional manner Both of these primary storage devices may include any suitable computer-readable media such as those described above. A mass storage device 1008 is also coupled bi-directionally to CPU 1002 and provides additional data storage capacity and may include any of the computer-readable media described above. Mass storage device 1008 may be used to store programs, data and the like and is typically a secondary storage medium such as a hard disk that is slower than primary storage. It will be appreciated that the information retained within the mass storage device 1008, may, in appropriate cases, be incorporated in standard fashion as part of primary storage 1006 as virtual memory. A specific mass storage device such as a CD-ROM or DVD-ROM 1014 may also pass data uni-directionally to the CPU.

CPU 1002 is also coupled to an interface 1010 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to a computer or telecommunications network using a network connection as shown generally at 1012. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for calculating a CDF may be stored on mass storage device 1008 or 1014 and executed on CPU 1008 in conjunction with primary memory 1006. It is noted that features of embodiments of the present systems may be implemented with hardware, software, firmware, or combinations thereof.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, data source or sources, process, process step or steps, to the objective, spirit and scope of the present invention. All such modifications are intended to be within the scope of the claims appended hereto.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method of removing labeling-bias factors affecting data from two or more data sources, said method comprising the steps of:
subdividing combined respective data points from the two or more data sources into portions of the population of combined data points;
for each portion, sorting the data points that are members of that portion according to relative values of the data points that are members;
for each portion, generating a function from the sorted data points belonging to that portion;
for each function, identifying a value representative of highest population density of data points within the respective portion;
fitting the values representative of highest population densities within the portions, respectively to a predetermined curve; and
adjusting values of all data points relative to the fitted values.

2. The method of claim 1, further comprising plotting said data points from two or more data sources against one another, respectively.

3. The method of claim 2, wherein two data sources are considered and said plotting comprises plotting data values from a first of said sources against respective data values from a second of said sources.

4. The method of claim 1, wherein said data sources are microarray channels and said data points are representative of signal values from said channels.

5. The method of claim 1, wherein said subdividing comprises binning the population into portions of the population.

6. The method of claim 1, further comprising displaying the adjusted values of data points.

7. The method of claim 1, wherein said portions are created by passing a moving window over the population of combined data points.

8. The method of claim 1, wherein data points within each of said portions are not all mutually exclusive of one another.

9. The method of claim 1, wherein said function comprises a cumulative distribution function.

10. The method of claim 1, wherein, for each function, the value representative of highest population density of data points within the respective portion is identified by identifying an inflection point of the function.

11. The method of claim 9, wherein, for each cumulative distribution function, the value representative of highest population density of data points within the respective portion is identified by identifying an inflection point of the cumulative distribution function.

12. The method of claim 11, wherein each said inflection point is identified using a convolution filter based on a fast Fourier transform.

13. The method of claim 1, further comprising:
plotting respective data points from first and second of the data sources against one another; and
repositioning an entire population of said plotted respective data points so that highest population density values over the entire population approximate a predetermined curve.

14. The method of claim 13, wherein the predetermined curve is a straight line coincident with one of two axes according to which said respective data points were plotted.

15. The method of claim 13, wherein the population is repositioned by applying principal components analysis to rotate the population relative to the predetermined curve.

16. The method of claim 13, wherein the population is repositioned by applying regression analysis to project the population relative to the predetermined curve.

17. The method of claim 13, further comprising repositioning the population again, after said adjusting values of all data points relative to the fitted values, by repositioning inversely to said repositioning to approximate the predetermined curve.

18. A method of dye-normalizing array data obtained from at least two channels, said method comprising the steps of:
subdividing a combined population of signal values from the at least two channels into portions of the overall combined population of signal values;
for each portion, sorting the signal values that are members of that portion according to relative values of the signal values that are members;
for each portion, generating a function from the sorted signal values belonging to that portion;
for each function, identifying a value representative of highest population density of signal values within the portion;
fitting the values representative of highest population densities within the portions, respectively to a predetermined curve; and
adjusting values of all signal values relative to the fitted values based upon the adjustments made to fit the fitted values.

19. The method of claim 18, wherein said identifying comprises identifying the mode of each said function.

20. The method of claim 18, further comprising plotting said respective signal values against one another.

21. The method of claim 18, wherein said function comprises a cumulative distribution function.

22. The method of claim 20, further comprising repositioning an entire population of said plotted respective signal values so that highest population density values over the entire population approximate a predetermined curve.

23. The method of claim 22, wherein the predetermined curve is a straight line coincident with one of two axes according to which said respective signal values were plotted.

24. The method of claim 22, wherein the population is repositioned by applying principal components analysis to rotate the population relative to the predetermined curve.

25. The method of claim 22, wherein the population is repositioned by applying regression analysis to project the population relative to the predetermined curve.

26. The method of claim 13, further comprising repositioning the population again, after said adjusting values of all signal values relative to the fitted values, by repositioning inversely to said repositioning to approximate the predetermined curve.

27. A system for removing labeling-bias factors affecting data from two or more data sources, said system comprising:
a feature for considering respective data points from said sources in combination;
a feature for subdividing the combined respective data points into portions of the overall population of combined data points;
for each portion, a feature for sorting the data points that are members of that portion according to relative values of the data points that are members;
for each portion, a feature for generating a function from the sorted data points belonging to that portion;
for each function, a feature for identifying a value representative of highest population density of data points within the respective portion;
a feature for fitting the values representative of highest population densities within the portions, respectively to a predetermined curve; and
a feature for adjusting values of all data points relative to the fitted values.

28. The system of claim 27, further comprising a feature for plotting said respective data points from said data sources against one another.

29. The system of claim 28, further comprising a feature for repositioning an entire population of said plotted respective data points so that highest population density values over the entire population approximate a predetermined curve.

30. The system of claim 29, further comprising a feature for repositioning the population again, after adjusting said values of all data points relative to the fitted values, by repositioning inversely to said repositioning to approximate the predetermined curve.

31. A computer readable medium carrying one or more sequences of instructions for removing labeling-bias factors affecting data from two or more data sources, wherein execution of one or more sequences of instructions by one or more processors causes the one or more processors to perform the steps of:
subdividing combined respective data points into portions of the overall population of combined data points;
for each portion, sorting the data points that are members of that portion according to relative values of the data points that are members;
for each portion, generating a function from the sorted data points belonging to that portion;
for each function, identifying a value representative of highest population density of data points within the respective portion;
fitting the values representative of highest population densities within the portions, respectively to a predetermined curve; and
adjusting values of all data points relative to the fitted values.
